(19) United States
(12) Patent Application Publication
(10) Pub. No.: US 2015/0118632 A1
(43) Pub. Date: Apr. 30, 2015

(54) Industrial Conveyor Oven

(71) Applicant: Mingsheng Liu, Omaha, NE (US)

(72) Inventor: Mingsheng Liu, Omaha, NE (US)

(21) Appl. No.: 14/529,043

(22) Filed: Oct. 30, 2014

Related U.S. Application Data
(60) Provisional application No. 61/897,945, filed on Oct. 31, 2013.

(51) Int. Cl. F27B 9/12; F27D 9/00; F27B 9/36

(52) U.S. Cl. CPC F27B 9/12; F27B 9/36; F27D 9/00; F27B 2009/124
USPC 432/122

(57) ABSTRACT

A conveyor oven for heating and cooling a material at varying air temperatures is proposed. The conveyor oven houses a conveyor and a plurality of climate controlled heating and cooling zones through which the material is transported. In a preheating zone, the material is heated to a desired temperature by at least one cooling fan system that provides exhaust air to the zone. In a heating zone, the material is heated by a heating system cycle comprising an air compressor, a turbine combustor, a turbine preheater, a turbine, a generator, a turbine combustor, and a combustor. In a cooling zone, the material is cooled to a desired temperature by at least one air fan system. Material that has been heated and cooled in the conveyor oven exists via the conveyor belt where it is removed by human and/or machine means.

### CROSS-REFERENCE TO RELATED APPLICATIONS

This application claims the benefit of U.S. Provisional Patent Application Ser. No. 61/897,945 filed on Oct. 31, 2013.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD

The disclosed embodiments generally relate to industrial conveyer ovens, and, more particularly, to an industrial conveyor oven used in industrial materials manufacturing.

### DESCRIPTION OF THE RELATED ART

Industrial conveyer ovens are typically used in the industrial materials manufacturing industry for high volume processing of manufactured and other goods. Products produced by conveyer ovens include china, bricks, ceramics, and other materials. Industrial ovens consume a significant amount of gas or fuel. High density energy (such as gas and oil) is used to produce thermal energy. As a result of the mismatch between the heating and cooling air flows, about 30% of its thermal energy is wasted.

FIG. 1 is an illustration of the components of a conventional industrial conveyor oven in the prior art. Typical prior art industrial conveyor oven system 100 is shown in FIG. 1 of the drawings. Prior art industrial conveyer ovens typically are divided into three or four sections where items are either heated or cooled. Materials placed on the conveyer are heated and cooled as they enter the oven system, first passing through the pre-heating and heating sections of the oven and then through the quick cooling and cooling sections.

In a method in the prior art, a material is placed on the conveyor belt in pre-heating section 101 of the oven and is warmed as it travels along the conveyor belt through the system. An exhaust fan 102 located at pre-heating section 101 emits exhaust air to the outside environment. Combustor 104 is designed to convert oil or gas into thermal energy. The thermal energy is then delivered to heating section 103 in the form of hot air. Often, prior art conveyor ovens have a plurality of combustors. Combustor fan 105 is located upstream of combustor 104 and provides the required combustion to the combustor. Combustion air control damper 106 is located upstream of combustor fan 105 and, based on the need, provides outside air or exhaust air from the cooling section of the conveyor oven to combustor 104.

A combustion air control damper, such as combustion air control damper 106 as illustrated in FIG. 1, is also often employed in the prior art. Combustion air control damper 106 provides either outside air or exhaust air from the cooling section of the oven to the combustor. When exhaust air is used, gas or fuel consumption is reduced. Once the material has passed through the heating section, it enters quick cooling section 107 where the material is cooled. Notably, not all industrial ovens include a quick cooling section. Outside air is then sent to the end of the oven heating section. Quick cooling fan 108 is connected to quick cooling section 107 and functions to send outside air to the end of heating section 103, cooling the material. As the conveyed material enters cooling section 110, exhaust fan 109 exhausts the cooled air to the oven exterior. Exhaust air fan 109 is typically located at the entrance of cooling section 110. In cooling section 110 the product is cooled as it moves against the direction of the airflow. Cooling air fan 111 is connected to cooling section 110 and supplies outside air to the cooling section. The exhaust airflow is comprised of air from quick cooling fan 108 and cooling air fan 111. This airflow is often 3 to 8 times greater than the combustion airflow.

The previously described prior art conveyor oven system and those like it continue to have a variety of unsolved issues. In the prior art system, there is limited energy heat recovery due to the unmatched cooling and combustion airflows. A significant amount of air is exhausted to the outside via exhaust fan 109. The temperature of this exhaust air can be as high as 1,000° F. More than 30% of the gas/fuel energy is wasted since it is carried to the outside air by the exhaust air.

In prior art systems, high density energy is also improperly utilized. In these systems, gas and/or oil is directly used for the production of thermal energy. The systems also have poor monitoring and control means resulting in the excessive use of fan power and poor quality control. Both the supply and exhaust air fans of said systems are maintained at a fixed speed and rate of airflow rather than set based on the actual outside air temperature. When set at fixed rates, the actual product temperature fluctuates according to the outside air temperature, such that the quality of the product cannot be ensured. When the fan is sized based on the highest outside air temperature, the fan power is 10% or sometimes even 20% higher than required.

In order to solve the issues in the prior art, a conveyor oven system is proposed to maximize the heat recovery, generate electricity that has high density energy, improve the quality of the product, and reduce the use of fan power. The advantages of this conveyor system are described in more detail in the following:

All system fans of the conveyor system are equipped with fan airflow stations and speed modulation devices. The fans are controlled based on volumetric tracking to ensure that proper air balance is achieved. A combustion turbine is installed as part of the system to generate electricity, thereby reducing the cost of fuel by as much as 60%. The combustion turbine system pre-heats compressed air using the exhaust air from the cooling section. This can reduce the combustion turbine gas consumption by as much as 30%. The total power generated by the system is therefore higher than 50% of the thermal energy input.

Modulation valve 222 is modulated to ensure the oven temperature is adequate. The gas input is modulated to ensure complete combustion. Exhaust fan 240 is equipped with a fan airflow meter. The fan speed is controlled so that the fan airflow is equal to the sum of the quick cooling and cooling airflows. The exhaust distributed intake system allows a minimum airflow rate to flow into and out of the end of the conveyor oven.

It is therefore an embodiment of the proposed system to use the modulation device and temperature set point to control the supply fans, measure the supply airflow, and ensure a proper airflow direction and system air balance.

It is an additional embodiment of the proposed system to reduce fan energy consumption by as much as 50%, and to control the oven temperature with increased precision.

It is an additional embodiment of the proposed system to maximize the heat recovery by moving the exhaust air in the cooling section of the conveyor to the pre-heating section.

It is yet an additional embodiment of the proposed system to maximize heat recovery through the utilization of all exhaust air in the pre-heating section. This reduces gas energy consumption by as much as 30-50%.

It is a further embodiment of the proposed system to control the pre-heating exhaust using a velocity meter to prevent excessive air leakage into or out of the conveyor oven.

It is yet a further embodiment of the proposed system to convert part of the high density thermal energy into electrical energy using a turbine generator. This reduces energy costs by as much as 60%.

### SUMMARY OF THE INVENTION

The following summary of the invention is provided to facilitate an understanding of some of the innovative features unique to an embodiment of the present invention and is not intended to be a full description. A full appreciation of the various aspects of the invention can be gained by taking the entire specification, claims, drawings, and abstract as a whole.

In an embodiment, a conveyor oven for heating and cooling a material at varying air temperatures is proposed. The conveyor oven houses a conveyor and closed climate controlled zones through which the material is transported and processed. In an embodiment, the climate controlled zones include at least one of a pre-heating zone, a heating zone, and a cooling zone.

A plurality of cooling fan systems configured in connection in the ductwork with the cooling zone provide exhaust air that heats the material as it is transported on the conveyor belt through the pre-heating zone. At least one exhaust fan system configured in connection in the ductwork with the cooling zone controls the airflow so that it flows at the level of the sum of the total air supply from the supply air fan systems. A combustor configured in connection in the ductwork with the heating section heats the material as it passes through the heating zone. If the air temperature in the heating section is lower than a setpoint value, gas is added to the combustor. If less than the set point value, then gas is released from the combustor. In order to heat the heating zone at the desired temperature, the embodiment also includes an air heating system cycle comprising an air compressor configured to compress entering outside air, a turbine combustor for increasing the temperature of the compressed air, a turbine preheater for mixing the compressed air with the hot exhaust air from the cooling supply fans, a turbine to generate electricity and low temperature and pressure exhausted air, a generator for generating power and configured in connection with said turbine, and a damper for modulating the exhaust air pressure entering the combustor. In the embodiment, the conveyor belt transports the material to a cooling zone where it is cooled to a desired cooling temperature. An air fan system configured in connection with said cooling system maintains the temperature of the cooling zone according to a desired setpoint. Material that has been processed in the conveyor oven exists via the conveyor belt where it is removed by human or machine means.

In other embodiments, the conveyor oven also includes a quick cooling zone configured in between the heating and cooling zones. In embodiments in which it is included, material exiting the heating zone is immediately transported to the zone. A cooling fan system is configured in connection to said quick cooling zone and maintains the temperature of the cooling zone according to a desired setpoint.

The above-described summary, features, and advantages of the present disclosure thus improve upon aspects of those systems and methods in the prior art designed to process materials through a conveyor oven.

### BRIEF DESCRIPTION OF THE DRAWINGS

It will be appreciated that for simplicity and clarity of illustration, elements illustrated in the following Figures have not necessarily been drawn to scale. For example, the dimensions of some of the elements are exaggerated relative to other elements for clarity. Advantages, features and characteristics of the present disclosure, as well as methods, operation and functions of related elements of structure, and the combination of parts and economies of manufacture, will become apparent upon consideration of the following description and claims with reference to the accompanying drawings, all of which form a part of the specification, wherein like reference numerals designate corresponding parts in the various figures, and wherein:

FIG. 1 a schematic diagram embodying the principles of a prior art conveyor oven system.

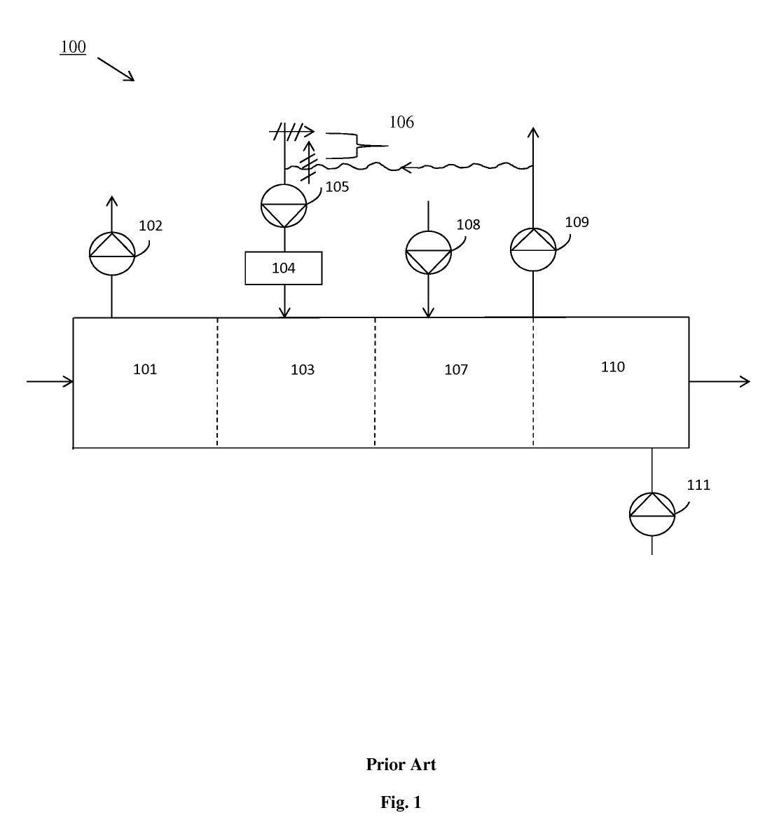

FIG. 2 is a schematic diagram of the system embodying the principles of the present invention.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a”, “an,” and “the” include plural references unless the context clearly dictates otherwise. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention.

### DRAWINGS REFERENCE NUMERALS

### Prior Art

100 Prior Art Industrial Conveyor Oven
101 Pre-heating Section
102 Exhaust Fan
103 Heating Section
104 Combustor
105 Combustor Blower/Fan
106 Combustion Air Control Damper
107 Quick Cooling Section
108 Quick Cooling Fan
109 Exhaust Fan
110 Cooling Section
111 Cooling Air fan
200 Industrial Conveyor Oven
201 Conveyor Belt
202 Preheating Section
204 Heating Section
206 Quick Cooling Section
208 Cooling Section
210 Pre-heat Temperature Sensor for Combustion Turbine
212 Quick Cooling Supply Air Fan System
214 Exhaust Air CO Sensor
216 Exhaust Fan System A
218 Air Velocity Sensor
220 Supply Air Static Pressure Sensor
222 Modulation Damper
224 Combustor
226 Generator
228 Turbine
230 Air Compressor
232 Turbine Combustor
234 Turbine Pre-heater
236, 238 Air Modulation Dampers
240 Exhaust Fan System B
242 Quick Cooling Section Temperature Sensor
244 Cooling Section Temperature Sensor
246 Exhaust Air Balance System
248 Cooling Supply Air Fan System

### DETAILED DESCRIPTION

In the following description, it should be understood that although the illustrated embodiment may be described as having a particular sense of motion from one end to the other, motions and flows may be in any direction in other embodiments of the invention. It should also be noted that directional terms such as upstream, downstream, in vicinity of, and near are used with respect to the coordinate system of the drawing figures and may thus differ from embodiment to embodiment.

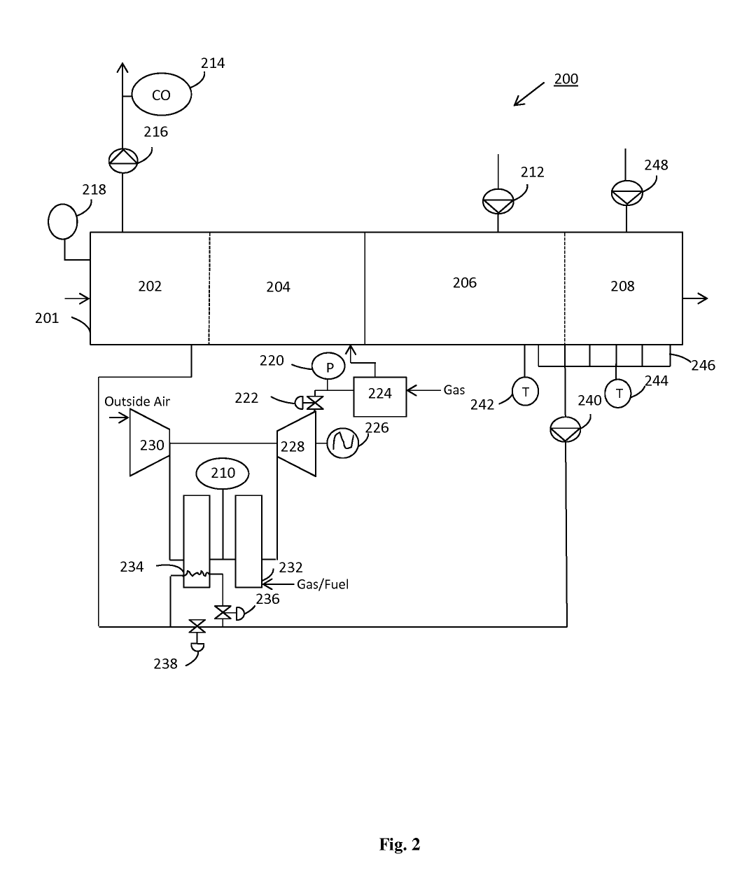

An embodiment for a conveyor oven system is provided. In the embodiment illustrated (FIG. 2), industrial conveyor oven system 200 is comprised of conveyor belt 201 having preheating section 202, heating section 204, quick cooling section 206, and cooling section 208. System 200 is also comprised of pre-heat temperature sensor for combustion turbine 210, quick cooling supply air fan system 212, exhaust air CO sensor 214, exhaust fan system A 216, air velocity sensor 218, supply air static pressure sensor 220, modulation damper 222, combustor 224, generator 226, turbine 228, air compressor 230, turbine combustor 232, turbine pre-heater 234, air modulation dampers 236 & 238, exhaust fan system B 240, quick cooling section temperature sensor 242, cooling section temperature sensor 244, exhaust air balance system 246, and cooling supply air fan system 248.

In the illustrated embodiment, industry oven 200 is an industrial conveyor oven used for manufacturing processes. A human operator or machine places a material on conveyor belt 201 so that it can be processed in oven 200. Conveyor belt 201 transports the material from one end of oven 200 to the other so that the material passes through enclosed climate controlled zones or “sections”. In the illustrated embodiment, the material is transported along conveyor belt 201 through pre-heating section 202, heating section 204, quick cooling section 206, and cooling section 208 where it is heated and cooled. Notably, in some embodiments, industry oven 200 does not include quick cooling section 206. After processing in oven 200, the material is picked up at the opposite end of conveyor belt 201 by machine or human means.

In the embodiment, conveyor pre-heating section 202 is the first section of the conveyor system that materials pass through. In this section, thermal energy is recovered from the hot air (exhausted combustion and cooling air). Air velocity sensor 218 is connected to preheating section 202 and is configured to measure the velocity of air as it enters oven system 200. Exhaust fan system A 216 is located in the ductwork in connection with pre-heating section 202 and exhaust air CO sensor 214. In some embodiments, fan system A 216 comprises an exhaust fan, fan airflow station, and fan speed modulation device, however in other embodiments it may be comprised of only one of the three stated components (exhaust fan or fan airflow station or speed modulation device). Exhaust fan system A 216 is configured to control the fan speed so that it matches the measured exhaust airflow at the level of the sum of the total air supply from the quick cooling and cooling supply air fan systems (212 & 248, respectively).

Exhaust air CO sensor 214 is located in the ductwork upstream of exhaust fan system A 216 and is configured to detect the actual concentration of CO at the exhaust duct. The concentration is maintained at a pre-set level to ensure complete combustion of combustor 224. Combustor 224 is connected in the ductwork in connection with heating section 204 and modulation damper 222 and utilizes engine exhaust air and fuel. The fuel intake into combustor 224 is modulated by the heating section temperature set point. Conveyor heating section 204 is connected to pre-heating section 202. Combustion air enters conveyor heating section 204 to warm the material on the conveyor to the desired temperature. If the temperature is lower than the set point value, gas is added to combustor 224. If the temperature is higher than the set point value, gas is released from combustor 224.

Air compressor 230 is located in the ductwork in connection with pre-heater 234 and turbine 228 and is configured to compress fresh air to a high pressure for use in turbine pre-heater 234. Turbine combustor 232 is located in the ductwork between air compressor 230 and turbine 228. The turbine combustor heats compressed air by combusting fuels or gas. Turbine combustor 232 also ensures that the required temperature is maintained at the entrance to turbine 228. The entering air temperature is selected based on the required combustion temperature of combustor 224. Turbine combustor 232 is controlled by modulating the gas intake to maintain the turbine inlet temperature set point. Combustion turbine pre-heat temperature sensor 210 is located in the ductwork in connection with turbine combustor 232 and turbine pre-heater 234 and is configured to measure the compressed air temperature entering gas turbine combustor 232. Turbine pre-heater 234 is located in the ductwork between air compressor 230 and turbine combustor 232. The compressed air temperature can be increased to up to 1,000° F. As a result, gas/fuel consumption of the combustion turbine can be reduced by half. The combustion pre-heater modulates dampers 236 & 238 to maintain the pre-heater supply air temperature. Supply air static pressure sensor 220 is configured in the ductwork in connection with combustor 224 and measures the heating section combustor supply air static pressure.

Air modulation dampers 236 & 238 are located in the ductwork in connection with and configured to modulate the amount of air flowing through turbine pre-heater 234. The airflow is modulated to maintain the required temperature set point at the entrance of the turbine combustor 232. Modulation dampers 236 & 238 are coupled together so that they open and close in opposition (wherein one damper is open when the other is closed).

Exhaust fan system B 240 is located downstream of quick cooling section 206 and cooling section 208. It is comprised of a fan, fan airflow station, and fan speed modulation device. System 240 modulates the fan speed to control the exhaust air flow at a rate equal to the sum of the airflow derived from the air fan systems (Quick Cooling Supply Air Fan System 212 and Cooling Supply Air Fan System 248). Turbine 228 is located in the ductwork in connection with modulation damper 222 and configured to generate electricity and produce low temperature and pressure exhausted air.

Modulation damper 222 is located in connection with supply air static pressure sensor 220 and is configured to modulate the exhaust air pressure at the entrance of combustor 224. Supply air static pressure sensor 220 is configured to measure the supply air static pressure for combustor 224. Combustor 224 is located in connection with supply air static pressure sensor 220 and is powered by engine exhaust air and fuel. The fuel intake is modulated by the heating section temperature set point. Combustor 224 is configured to modulate damper 222 so that the static pressure at the entrance of the combustor remains at a value above the minimum. The damper position can be modulated to ensure the concentration of CO is at the set point. The gas intake is modulated to maintain the heating section temperature set point. If the heating section temperature is lower than the set point, the gas injection is increased. If the heating section temperature is higher than the set point, the gas injection is decreased.

Quick Cooling Section 206 is located on the conveyor between heating section 204 and cooling section 208. While shown in the embodiment illustrated in FIG. 2, other embodiments may not include this section. Section 206 is configured to quickly and directly cool the material/product with outside air after it passes through heating section 204. Quick Cooling Supply Air Fan System 212 is comprised of a supply air fan, fan airflow meter, and fan speed modulation device and is located upstream of quick cooling section 206. Fan system 212 modulates the fan speed to maintain the required quick cooling temperature set point. If the actual temperature is lower than the set point, the fan speed is slowed down. If the actual temperature is higher than the set point, the fan speed is increased.

Quick Cooling Section Temperature Sensor 242 is located in the ductwork in connection with quick cooling section 206 and is configured to measure the actual quick cooling temperature. In FIG. 2, the temperature sensor is a single sensor, but other embodiments may include a plurality of temperature sensors. Cooling Section Temperature Sensor 244 is located in the ductwork in connection with cooling section 208 and is configured to measure the actual cooling section temperature. In the shown Figure only a single sensor is shown. However, in other configurations or embodiments there can be a plurality of sensors.

Cooling Section 208 is located at the end of the conveyor belt 201 of industry oven 200. Cooling air is introduced and flows in the opposite direction of the direction of movement of the material as it passes through this section. Cooling Supply Air Fan System 248 is located in the ductwork in connection with cooling section 208 and is comprised of a supply air fan, fan airflow station, and fan speed modulation device. The fan speed is modulated to maintain the cooling section at the required temperature set point as measured by cooling section temperature sensor 244. If the actual temperature is lower than the set point, the fan speed is slowed down. However, if the actual temperature is higher than the set point, the fan speed is increased.

Generator 226 is connected in the ductwork to turbine 228 and generates power for use in turbine 228 and air compressor 230. Exhaust Air Balance System 246 is connected to cooling section 208 and has multiple air intakes. The air balance system balances the air flowing throughout the system. In particular, it adjusts the airflow to ensure very little to no air enters or exits the end of industrial conveyor oven 200.

The above-described features and advantages of the present disclosure thus improve upon aspects of prior art systems and methods.

What is claimed is:

1. A conveyor oven system for heating and cooling a material, comprising:
a plurality of heating and cooling zones housed within said conveyor oven system, said plurality of heating and cooling zones comprising at least one of a preheating zone, a heating zone, and a cooling zone;
at least one exhaust fan system configured in ductwork connection with said cooling zone and configured to send exhaust air to said preheating and heating zones;
a combustor configured in ductwork connection with said heating zone and configured to heat said zone based on a setpoint value;
a heating cycle system using outside air and fuel in ductwork connection with said combuster and heating zone and configured to heat said heating zone, said heating cycle system comprising an air compressor configured to compress said air, a turbine combustor for increasing the temperature of said air, a turbine preheater for mixing said air with said exhaust air from said at least one exhaust fan system, a turbine combustor for heating said air with said fuel, a turbine for generating electricity and lowering the temperature and pressure of said air, a generator for generating power for use in said turbine, and a damper for modulating the pressure of said air for said combustor;
a cooling air supply fan system configured in the ductwork in connection with said cooling zone and configured to maintain a cooling section set point;
a conveyor for conveying said material through said plurality of cooling and heating zones, wherein said material is heated and cooled.

2. The conveyor oven system of claim 1, wherein said plurality of heating and cooling zones further comprise a quick cooling zone configured upstream of said cooling zone and configured to cool said material.

3. The conveyor oven system of claim 2, further comprising a quick cooling supply air fan system in ductwork connection with said quick cooling zone and configured to maintain a cooling temperature set point.

4. The conveyor oven system of claim 1, wherein said at least one exhaust fan system comprises at least one of an exhaust fan, fan airflow station, and fan speed modulation device.

5. The conveyor oven system of claim 1, wherein said at least one exhaust fan system comprises at least one exhaust fan.

6. The conveyor oven system of claim 1, wherein said at least one exhaust fan system comprises a fan airflow station.

7. The conveyor oven system of claim 1, wherein said at least one exhaust fan system comprises a speed modulation device.

8. The conveyor oven system of claim 1, wherein said at least one exhaust fan system comprises at least one of an exhaust fan, fan airflow station, and fan speed modulation device.
